(19) United States
(12) Patent Application Publication
(10) Pub. No.: US 2009/0117968 A1
(43) Pub. Date: May 7, 2009

(54) INCENTING INCREASED WAGER SIZES

(76) Inventors: Kevin KRIETEMEYER, Providence, RI (US); Derek Gwaltney, North Kingstown, RI (US)

Correspondence Address: IP Patent Docketing;K&L GATES LLP, 599 Lexington Avenue, 33rd Floor, New York, NY, 10022-6030, US

(21) Appl. No.: 12/263,642

(22) Filed: Nov. 3, 2008

Related U.S. Application Data
(60) Provisional application No. 61/001,619, filed on Nov. 2, 2007.

(51) Int. Cl. A63F 9/24; A63F 13/00

(52) U.S. Cl. 463/18; 463/27

(57) ABSTRACT

Example methods and systems for facilitating the play of a wagering game are provided with one or more progressive jackpots. The example methods and systems may have a better than linear increases in the probability of winning depending on increasing wager price points.

This application claims priority under 35 U.S.C. 119(e) to provisional patent application No. 61/001,619, filed Nov. 2, 2007, titled “METHOD AND SYSTEM FOR INCENTING INCREASED WAGER SIZES”. The entire disclosure of said provisional application is incorporated by reference herein by reference thereto.

### BACKGROUND

Number selection games like Keno have long been a staple of the gaming industry. They are played on physical boards, with bingo like player cards and numbered balls. They are played at individual machines as a video game. They are played casino wide, and Keno games are played as state or multi-state lottery games. They are simple to understand and desirable to players despite traditionally having one of the highest profit margins for operators (making them very desirable to operators). The profitability of a wagering game for operators is directly related to how popular that game is to players, and how much players are willing to wager while playing the game. Popularity of a game is often a function of both the perceived likelihood of winning and the entertainment appeal of the game itself. The game operator may be a private business trying to realize a profit, or a state government trying to realize important supplemental revenue through state lottery programs. Regardless, revenue maximization is a key goal, and in wagering games that typically retain a small percentage of the amount wagered, maximizing total wagers helps maximize total profits.

One approach to increasing both entertainment value and the perceived likelihood of winning is the use of a progressive jackpot. These designs allow a player to win a large jackpot. These larger jackpots are usually created by saving a small portion of the wager from a large number of wagers for the progressive jackpot. The probability of winning the progressive jackpot for any individual wager is small, so that the progressive jackpot has time to grow. Alternatively or additionally, the large jackpot is created by taking a small portion of the wagers from many different machines and many different players, allowing it to grow quickly because it is being fed by a large number of players. These large jackpots may increase player excitement, as the player knows there is a chance of a “life changing” jackpot prize. As an example, state lotteries are able to offer large jackpot awards by drawing players from all the residents and visitors of the state. Additionally, even larger jackpot lotteries are possible through multi-state lotteries.

### SUMMARY

One example embodiment of the present invention includes a method for facilitating the operation of a wagering game with a progressive jackpot. The example method may include receiving a player selection of a wager price point from a plurality of available price points for the wagering game. The example method may also include, conditioned on receiving the player selection of the wager price point, entering the player into a round of a base wagering game. In addition, the example method may include, conditioned on the player selection of the wager price point exceeding a first predetermined threshold, also entering the player into a progressive jackpot game, and may also include, conditioned on the player selection of the wager price point exceeding a second predetermined threshold, which is higher than the first predetermined threshold, also entering the player into a second progressive jackpot game.

Optionally, the example methods may include, responsive to the player selection of the wager price point exceeding the first predetermined threshold or the second predetermined threshold, generating at least one entry number, where a prize awarded for the game depends at least in part on the at least one entry number.

Optionally, the example methods may include receiving a selection of at least one entry number from the player, wherein award of a prize for the round of the base wagering game depends at least in part on the at least one entry number.

Optionally, the example methods may include randomly generating at least one outcome number, wherein award of a prize for the round of the base wagering game depends on the at least one outcome number.

Optionally, the base wagering game may be a number selection game, and the example methods may include receiving a selection of at least one entry number from the player chosen from a set of numbers; generating at least one outcome number chosen from the set of numbers; and awarding a prize for the round of the base wagering game based on the quantity of entry numbers that match outcome numbers.

Optionally, the set of numbers may include 80 numbers and the outcome numbers may include 20 numbers selected from the set of numbers.

Optionally, the base wagering game may be a number selection game, and the example methods may include awarding the first progressive jackpot and the second progressive jackpot based on the at least one outcome number used in the base wagering game.

Optionally, the base wagering game may be a number selection game, and the example methods may include awarding the first progressive jackpot based on a second number drawing separate from the base wagering game and awarding the second progressive jackpot based on a third number drawing separate from the base wagering game and the first progressive jackpot game.

Optionally, the first progressive jackpot may be a jurisdiction-wide progressive jackpot.

Optionally, the first progressive jackpot may be a multi-jurisdiction progressive jackpot.

Another example embodiment may include a method of providing a wagering game with a progressive jackpot. The example method may include receiving a player selection of a wager price point and responsive to receiving a selection of a first price point, entering the player into a base wagering game. The example method may also include, responsive to receiving a selection of a wager price point exceeding a second price point, higher than the first price point, entering the player into a progressive jackpot. The example method may also include responsive to receiving a selection of a wager price point exceeding of a third price point, higher than the second price point, entering the player into the progressive jackpot. In addition, a probability of winning the progressive jackpot associated with the entry exceeding the third price point, may be greater than a second probability of winning associated with the entry exceeding the second price point but less than the third price point, and an increase in probability between the probability and the second probability may be non-linear as compared to an increase in price between the second price point and the third price point.

Optionally, the wagering game may be a number selection game, and the example methods may include receiving a selection of at least one selected entry number chosen from a set of numbers; receiving a selection of at least one randomly selected outcome number chosen from the set of numbers; and awarding a prized based on how many selected entry numbers match outcome numbers.

Optionally, the example methods may include, responsive to receiving a selection of the second price point, issuing at least one player entry number and randomly selecting at least one outcome number, wherein the quantity of outcome numbers is greater than or equal to the quantity of player entry numbers; and awarding the progressive jackpot responsive to a determination that each player entry number matches an outcome number.

Optionally, the example methods may include responsive to receiving a selection of a price point exceeding the third price point, issuing at least one player entry number and selecting at least one outcome number, where the quantity of outcome numbers may be greater than or equal to the quantity of player numbers and the quantity of entry numbers may be less than a second quantity of entry numbers associated with the second price point. The example methods may also include awarding the progressive jackpot responsive to a determination that each player number matches a operator number.

Optionally, the set of numbers may include 80 numbers, and the outcome numbers may include 20 numbers.

Another example embodiment may include a system for facilitating a number selection game with a progressive jackpot. The example system may include an input device configured to receive a player selection of a wager amount chosen from a set of available wager amounts. The example system may also include a processor, and may also include an output device configured to inform the player of at least one winning number. In addition, the processor may be configured to receive at least one entry number, to receive randomly generated outcome numbers, and to determine whether a wager is a winner based on the at least one entry number and the randomly generated outcome numbers, where the probability of a winning wager may increase more than linearly with the chosen wager amount.

Optionally, the input device may be configured to accept paper tickets marked with the at least one number and the player selection of the wager amount.

Optionally, the input device may be an electronic kiosk configured to be operated by at least one of the player and a retail clerk, the input device may be configured to receive input indicating the at least one entry number and the player selection of the wager amount.

Optionally, the processor may be further configured to randomly choose the outcome numbers.

Optionally, the processor may be further configured to enter the player in a progressive jackpot game responsive to the selection of a first wager amount and the processor may be configured to issue at least one first set of numbers on which an award of a progressive jackpot depends. In addition, the processor may be further configured to enter the player in the progressive jackpot game responsive to the selection of a second wager amount, greater than the first wager amount, and the processor may be configured to issue at least one second set of numbers, of a lesser quantity than the first set of numbers, on which an award of the progressive jackpot depends.

Optionally, the processor may be further configured to enter the player in a progressive jackpot game, responsive to a first wager amount being selected which is greater than a minimum wager amount. In addition, the processor may be further configured to enter the player in a second progressive jackpot game responsive to a second wager amount being selected which is greater than a second minimum wager amount, the second minimum wager amount being greater than the minimum wager amount.

Another example embodiment may include a method of providing a number selection game with a progressive jackpot. The example method may include receiving a selection of a wager price point from a player, and may also include responsive to the wager price point being greater than or equal to a first price point, entering the player in a number selection game. The example method may also include responsive to the wager price point being greater than or equal to a second price point that is greater than the first price point, issuing the player a first quantity of numbers such that winning a jurisdiction-wide progressive jackpot game is dependant on the numbers in the first quantity of numbers. The example method may include, responsive to the wager price point being greater than or equal to a third price point, that is greater than the second price point, issuing the player a second quantity of numbers, smaller than the first quantity of numbers, such that winning a jurisdiction-wide progressive jackpot game is dependent on the numbers in the second quantity of numbers. The example method may include, responsive to the wager price point being greater than or equal to a fourth price point, greater than the third price point, making the first quantity of numbers eligible for a multi-jurisdiction progressive jackpot. In addition, the example method may include responsive to the wager price point being greater than or equal to a fifth price point, greater than the fourth price point, making the second quantity of numbers eligible for a multi-jurisdiction progressive jackpot.

Optionally, the example method may include selecting from a set of numbers some final quantity of numbers, and may also include determining winners based on matching the numbers in the first or second quantity of numbers with the final quantity of numbers.

Another example embodiment may include a system for facilitating the operation of a game. The example system may include an input means for receiving a player selection of a wager amount and player entry numbers. The example system may also include an entry means for entering the player's wager in the game, the player entry including additional chances to win conditioned on the player's wager exceeding predetermined thresholds. The example system may also include a randomization means for generating outcome numbers. In addition, the example system may include an outcome determination means for determining whether the player's wager wins a base game based on a comparison of the entry numbers and the outcome numbers.

Optionally, the additional chances to win may include entries in jurisdiction-wide progressive games.

Optionally, the additional chances to win may include entries in multi-jurisdiction progressive games.

Optionally, in the example methods, the player selection of a wager price point may be received by at least one of a dedicated gaming kiosk, a clerk-operated gaming terminal, a clerk-operated point-of-sale terminal, an unattended game ticket vending machine, a personal computer connected over the Internet to a lottery server, and a mobile telephone wirelessly connected to a lottery server.

Optionally, in the example methods, numbers may be selected by at least one of a software pseudo-random number generator on a gaming server, a firmware based pseudo-random number generator on a gaming server, a hardware based random number generator in communication with a gaming server, and a software pseudo-random number generator on gaming terminal.

Any of the example methods described above could be performed by a processor executing instructions encoded on a computer readable storage medium.

### BRIEF DESCRIPTION OF THE DRAWINGS

FIG. 1a illustrates a diagram of an example entry slip, according to one example embodiment of the present invention.

FIG. 1b illustrates a flowchart of an example procedure according to one example embodiment of the present invention.

FIG. 1c illustrates a diagram of an example pay slip, according to one example embodiment of the present invention.

FIG. 2a illustrates a diagram of another example procedure according to one example embodiment of the present invention.

FIG. 2b illustrates a diagram of an example procedure according to one example embodiment of the present invention.

FIG. 2c illustrates a diagram of an example video entry display according to one example embodiment of the present invention.

FIG. 3a illustrates a diagram of another example procedure according to one example embodiment of the present invention.

FIG. 3b illustrates a diagram of another example procedure according to one example embodiment of the present invention.

FIG. 3c illustrates a diagram of an example procedure according to one example embodiment of the present invention.

FIG. 4 illustrates a block diagram of an example system according to one example embodiment of the present invention.

FIG. 5 illustrates a block diagram of an example distributed system according to one example embodiment of the present invention.

### DETAILED DESCRIPTION OF EXAMPLE EMBODIMENTS

Applicant has observed that the appeal of progressive jackpot games provides a continuing need to improve upon those designs. Wagering games, whether table games at a casino or multi-jurisdiction lotteries, have an expected payout value equal to some fraction less than the wager value inputted. For example, in double-zero roulette the expected value of operator revenue is typically 5.26% of the wager (for all but one bet), and so for every dollar a player wagers the expected value of the return is $0.9474 with an expected house profit of $0.0526. The game operates by offering higher payouts with lower probabilities, but always an expected value in favor of the operator. In this arrangement, game profits are directly proportional to volume of betting. There exists two basic approaches to increase the volume of betting and thus increase game profits. First, increase the number of participants making bets. Second, increase the amount each participant is willing to wager. Either or both of these approaches will increase overall profits as they will increase overall wagering. The example embodiments discussed below are directed primarily toward the second approach with some features directed toward the first approach.

Some example embodiments of the present invention include systems and procedures for encouraging larger bets by providing a non-linear increase in the potential payout of a game as wagering increases. This may be accomplished with several different approaches, and example procedures are illustrated below.

Some example embodiments of the present invention are directed toward the number selection game called “Keno,” although it will be appreciated that they may be adapted by other future draw lottery games, particularly those based on number draws. The basic game of Keno has eighty numbers, numbered one to eighty. The player selects a certain quantity of numbers, which is called a “spot.” So for example, if a player is allowed to select six of the eighty numbers, that ticket is referred to as a “six-spot.” After a certain window of time has closed, betting for a particular game may end and the Keno operator may randomly select twenty of the eighty numbers. The player may then be paid a certain prize depending on how many of the numbers they selected are in the twenty numbers the operator selected. Each number from zero to the total spot value has an associated probability. So for example, in a two-spot the player selects two numbers from the eighty. Of those two numbers zero, one, or two may be found in the twenty selected by the operator. Each of those outcomes has an associated probability (e.g. it is approximately 56% likely zero of the player selected numbers are in the twenty, 38% likely one number is in the twenty, and 6% likely both numbers are in the twenty). The payouts associated with the various outcomes may change and depend on the game operator. The payouts should be set so that the expected value of the overall game is in the operator's favor.

An example set of probabilities was discussed with reference to a two-spot ticket. However, the probability of any outcome on any sized ticket may be calculated with the following equation: Pₙ(k)=((n choose k)*(80-n choose 20-k)/(80 choose 20)). In the equation “x choose y” is short for (x!/(y!*(x−y)!)). In the equation “n” is the size of the spot (e.g. n would equal six for a six-spot ticket). In the equation “k” is the quantity of spots the player selected that are found in the twenty spots the operator selected. The probability of selecting k numbers on an n-spot ticket is therefore Pₙ(k). For a number selection game that does not follow the basic 80/20 rule of Keno, the equation above may still be used to calculate the probability of any outcome by replacing 80 with the quantity of numbers from which numbers may be selected, and replacing 20 with the quantity of numbers the operator selects. Other embodiments of the present invention will be implemented with a variety of games including number selection games that do not use the standard 80/20 rule of keno.

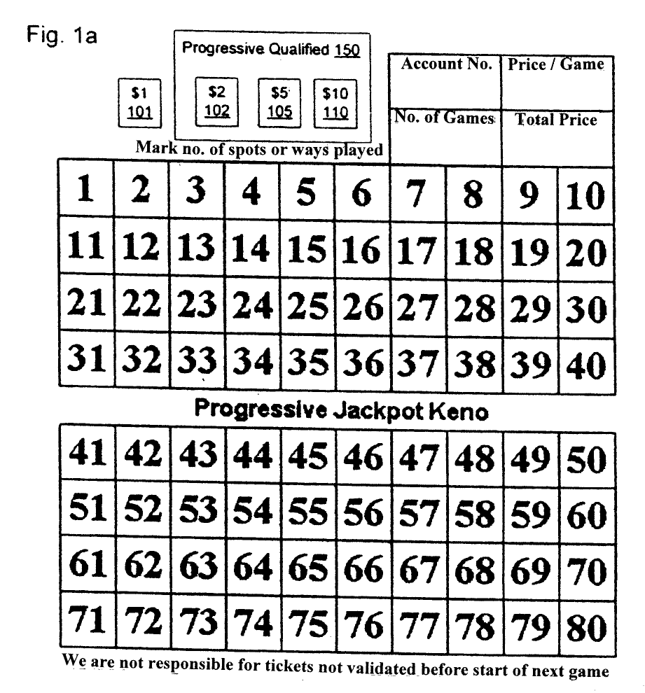

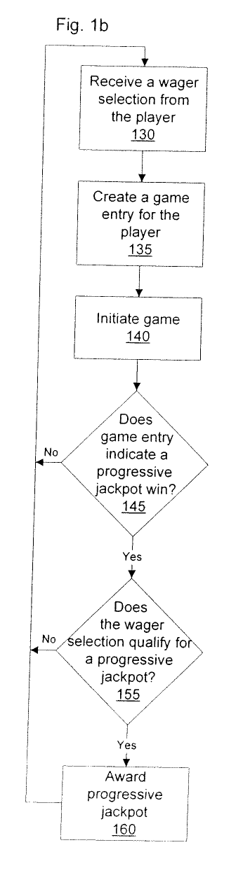

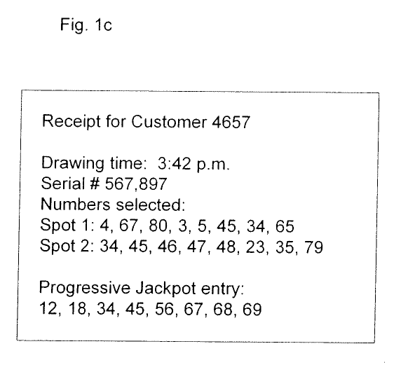

FIG. 1a illustrates a diagram of an example entry slip, according to one example embodiment of the present invention. FIG. 1a could illustrate one example of how price point options may be presented to a customer (e.g. an example play slip on an example input display or input card). As may be seen the player may be allowed to bet $1 (101), $2 (102), $5 (105), or $10 (110). This is only one example. The denominations could be any amount. The selection of $1 (101) may buy the player a Keno ticket in a round of Keno, but may not qualify the player for a chance to win a progressive jackpot. However, the selection of $2 (102), $5 (105), or $10 (110) may qualify the player for a progressive jackpot 150. In this example, the player may be encouraged to bet at least $2 in order to take advantage of the progressive game. It will be appreciated that different amounts of base, draw, or player selected numbers may be used, with appropriate changes to the odds and payouts.

FIG. 1b illustrates a flowchart of an example procedure according to one example embodiment of the present invention. At 130 a price point may be selected from a set of price points (e.g. the example price points illustrated in FIG. 1a). At 135 a game entry may be created for a player. In the example of a Keno game, this game entry may be a quantity of numbers selected from the overall set of numbers, for example by a player using an input device, or via a “quick pick” generated by a machine. In the example of a video poker game, this entry may be a hand dealt to a player. At 140 the game may be initiated. In one example related to a Keno game, the game initiation may include a draw of 20 numbers. In an example related to a video poker game, initiation could include flipping dealt cards over, or allowing a player to discard some quantity of cards to get to a final hand. Next, at 145, it may be determined if a player's entry indicates a progressive jackpot win. In one example related to a Keno game, this may include determining if player selected numbers are all found in a subset of 20 operator selected numbers. In an example related to a video poker game, this may include determining if a player has a royal flush or some other qualifying hand. If not the procedure may be reset for the next wager. However if a qualifying entry is found, at 155, it may be determined if the selected wager qualifies for the progressive jackpot. Using FIG. 1a as an example, if the player only bet $1 then the player may not receive the progressive jackpot. However, if the player selected $2 or more then the player may receive the progressive jackpot at 160.

FIG. 1c illustrates a diagram of an example pay slip, according to one example embodiment of the present invention. A pay slip, for example, may be issued to a player and may include a customer number, drawing time, serial number, or any other relevant information. The pay slip may contain number selections (whether selected by the player or automatically generated) for all of the player's entries. If the player wagered enough to qualify for a progressive jackpot, the slip may contain the progressive jackpot entry.

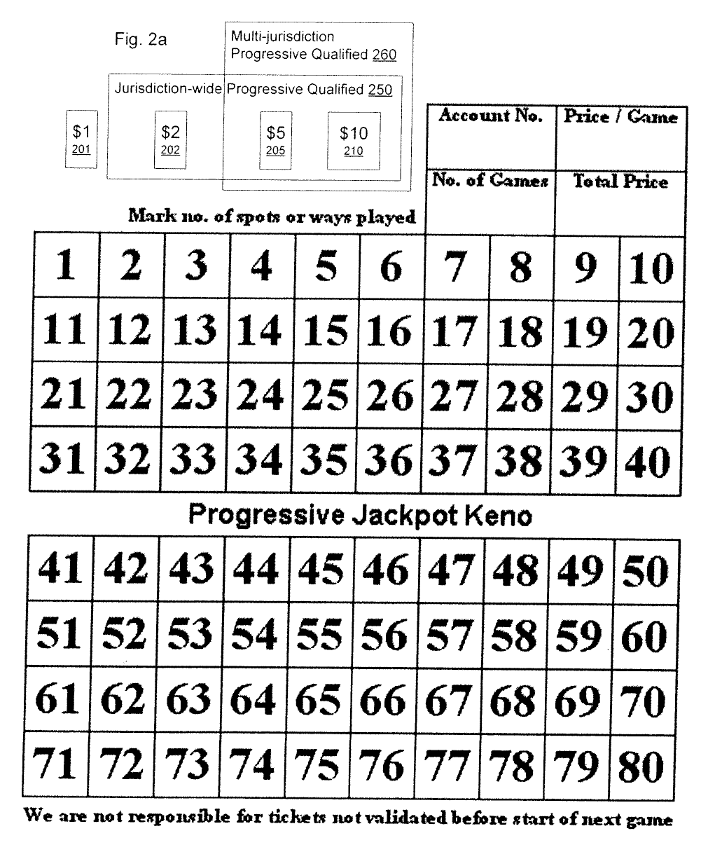

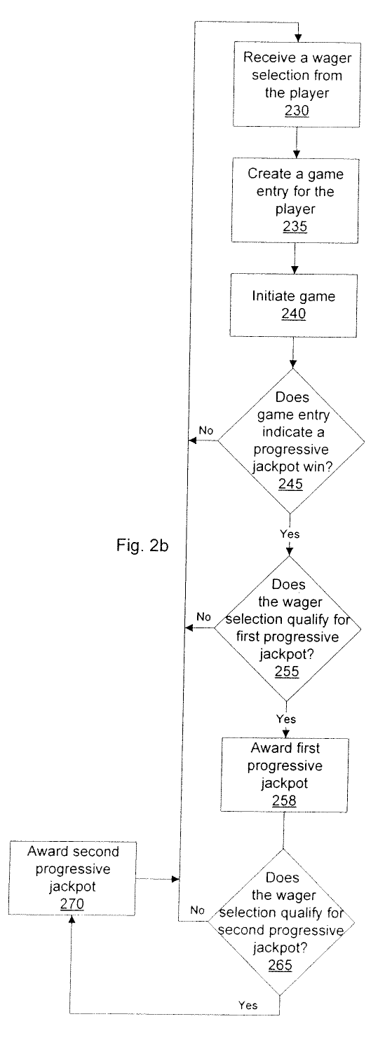

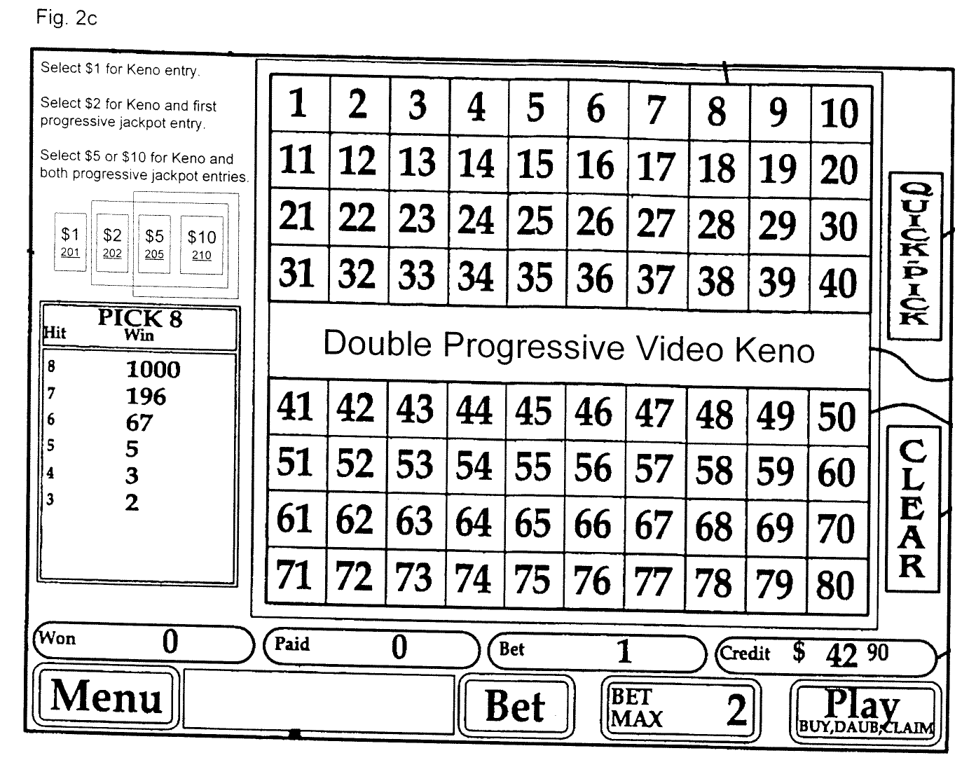

FIG. 2a illustrates a diagram of another example procedure according to one example embodiment of the present invention. FIG. 2a could illustrate one example of how to present wager selection choices to a customer (e.g. an example using a ticket or input display). The same elements may be present in FIG. 2 as in FIG. 1, but in figure two there may be a first progressive jackpot 250, and a second progressive jackpot 260. In an example, the first progressive jackpot may be operated jurisdiction-wide, and the second progressive jackpot may be a multi-jurisdiction jackpot. Typically, but not necessarily, the second jackpot may have a higher total jackpot. Here the player may be encouraged to wager at least $2 to be entered into the first progressive jackpot, and at least $5 to be entered into the second progressive jackpot.

FIG. 2b illustrates a diagram of an example procedure according to one example embodiment of the present invention. At 230 a wager may be selected from a set of price points (e.g. the example price points illustrated in FIG. 2a). At 235 a game entry may be created for the player. In an example related to a Keno game, this game entry may include a quantity of numbers selected from the overall set of numbers. In an example related to a video poker game, this entry may include a hand dealt to the player. At 240 the game may be initiated. In an example related to a Keno game, game initiation could include a draw of the subset of 20 numbers. In an example related to a video poker game, game initiation may include flipping the dealt cards over, or allowing the player to discard some quantity of cards to get to a final hand. Next, at 245, it may be determined if the player's entry indicates a progressive jackpot win. In an example related to a Keno game, this may include determining if the player selected numbers are all found in the subset of 20 operator selected numbers. In an example related to a video poker game, this may include determining if the player has a royal flush or some other qualifying hand. If not the procedure may be reset for the next wager. However, if a qualifying entry is found, it may be determined if the selected wager qualifies for a first progressive jackpot. Using FIG. 2a as an example, if the player only bet $1 then the player may not receive the first progressive jackpot. However, if the player selected $2 or more, then the player may receive the first progressive jackpot at 258. Next at 260, it may be determined if the selected wager qualifies for a second progressive jackpot. If the player selected $5 or more, then the player may receive the second progressive jackpot at 270. As mentioned, the first progressive jackpot may be jurisdiction-wide and the second progressive jackpot may be multi-jurisdictional, however, any two jackpots, partitioned in any manner could be possible in example embodiments.

The first jackpot and second jackpot may be separate jackpots associated with separate games, may be separate jackpots associated with the same game, or may be taken from the same jackpot. One example may include each operator at the jurisdiction-wide levels performing a drawing and awarding jurisdiction-wide prizes based on the winning numbers. A multi-jurisdiction operator (e.g. operating a server connected over a network to the individual jurisdictions) may determine if any participant in any jurisdiction won the multijurisdiction progressive jackpot. Another example may include separate drawings. For example, a player may be issued one progressive jackpot ticket with some quantity of numbers on it. Then the first jackpot operator (e.g. a jurisdiction level operator) may perform a number selection (e.g. picking the 20 winning keno numbers) and issue a jurisdiction level jackpot to anyone with a winning ticket (e.g. where all of a player's numbers are in the winning 20). Independently, the multi-jurisdiction operator may perform a separate number selection and award a share of the multi-jurisdiction jackpot to anyone with a winning ticket. This would be an example of jackpots associated with separate games. Alternatively, the player may be issued two sets of numbers; one for the jurisdiction level game and one for the multijurisdiction level game. Alternatively, a player may be issued one ticket with a quantity of numbers on it, there may be one number selection, and any jurisdiction-level winner may win a designated jurisdiction-level progressive jackpot, and any multijurisdiction level winner may win a designated multi-jurisdiction level progressive jackpot. This may be an example of separate jackpots associated with the same game. Alternatively, as an example of the two jackpots being taken from the same progressive jackpot, it may be the case that during a progressive jackpot play a jurisdiction-level winner of jurisdiction A wins some percent of the one jackpot, jurisdiction B some other percent of the jackpot, and so on while the remainder could be reserved for the multi-jurisdiction level winners of the one jackpot.

Although Keno and video poker were used to illustrate example procedures for encouraging higher wagers through the provision of multiple progressive jackpots tied to increasing price points, it should be appreciated that other games may also be used. In other examples embodiments, slot machines, or video slot machine games may be used. For example, at some price point a player may be eligible for a progressive jackpot associated with one or more slot terminals or a group of wagering games of various kinds. At a second price point the same player may be eligible for a progressive jackpot associated with an even larger group of game terminals. For example, a first progressive jackpot may be associated with all the slot machines of one casino and the second progressive jackpot may be associated with all the slot machines of multiple casinos. Other embodiments may involve video poker (as mentioned above), lottery terminals, or any other game to encourage higher price point betting through multiple progressive jackpots.

FIG. 2c illustrates a diagram of an example video entry display according to one example embodiment of the present invention. The video display of 2c may contain instructions and graphic entry buttons for displaying and allowing a player to select a wager price point that may qualify for a progressive jackpot. The video display of FIG. 2c is but one example, and may work in conjunction with user input devices or other peripherals. The video display of FIG. 2c may be connected to a server or terminal which may be connected to a server.

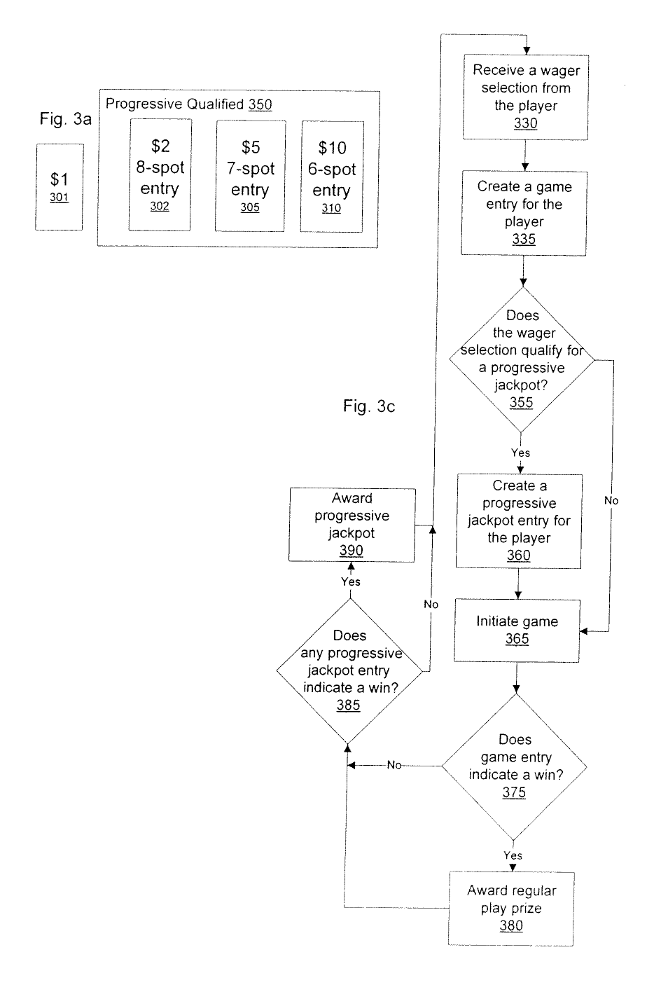

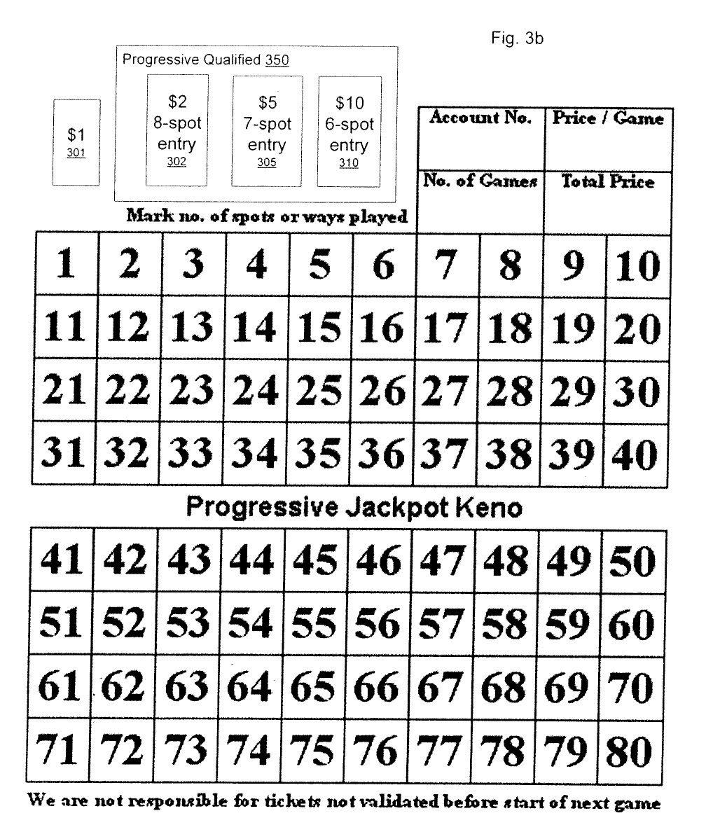

FIG. 3a illustrates a diagram of another example procedure according to one example embodiment of the present invention. In this example procedure a first bet (e.g. $1) may buy a round of the number selection game (e.g. Keno), but may not qualify for a chance at the progressive jackpot. The $2 to $10 wagers may qualify for the progressive jackpot and may correspond with different odds of winning. For those wager levels the player may be issued a progressive jackpot spot ticket. For the second level (e.g. $2) the player may be issued an eight-spot ticket, for the third level (e.g. $5) the player may be issued a seven-spot ticket, and for the fourth level (e.g. $10) the player may be issued a six-spot ticket. These are merely examples and any wager levels may be used, and any spot levels may be associated with the wagers. It would be preferred that spot levels decrease as wagers increase, and it would be additionally preferred that the increase in probability of winning be better than linear. There may also be more than four price points, more than one non-qualifying price point, or more than 3 qualifying price points.

FIG. 3b illustrates a diagram of another example procedure according to one example embodiment of the present invention. FIG. 3b is one example of how the selection options described in FIG. 3a might be presented to a player. In an example, an entry ticket may be show the type of progressive jackpot entry the player may qualify for depending on the wager price point the player selects.

FIG. 3c illustrates a diagram of an example procedure according to one example embodiment of the present invention. At 330 a wager selection may be received, e.g. from the player. A game entry may be created for the player at 335. This may be for the base game, and, in an example related to Keno, it may include a player selected quantity of numbers from which the prize awarded may be determined. At 355 it may be determined if the wager selected qualifies for an entry in a progressive jackpot. According to the example illustrated in FIG. 3a, which uses the game Keno as an example game, at 360 a progressive entry for the $1 price point not be created, an eight-spot entry for the $2 price point may be created, a seven-spot entry for the $5 price point may be created, and a six-spot entry for the $10 price point may be created. The relative advantages of those selections is discussed below. The game may be initiated at 365. If the first entry is a winner, at 375, a regular play prize may be awarded, at 380. Regardless, it may be determined if the progressive jackpot entry (whether eight-spot, seven-spot, or six-spot) is a winner at 385. If so, the progressive jackpot may be awarded at 390, and regardless the procedure may return to waiting for a wager selection at 330.

Using the probability function described above, the example procedure illustrated in FIG. 3 may provides a probability of winning the progressive jackpot at the $2 price point of P₈(8) or 0.000435%. The probability of winning the progressive jackpot with a seven-spot ticket may be P₇(7) or 0.002440%. The wager level may be only 2.5 times as high, but the probability of winning the jackpot may be more than 5.6 times as high. This may provide a high, better than linear, incentive for a player to wager at least $5. The probability of winning the progressive jackpot with a six-spot ticket may be P₆(6) or 0.0129%. Here the wager level may be twice as much as the $5 level, but the probability of winning may again be over 5 times better.

Though the number selection game of Keno was used to illustrate an example procedure of an embodiment of the present invention, it should be appreciated that example procedures may be implemented with any number of games, for example video poker. In a standard game of video poker a player is dealt 5 cards and different hands (e.g. a pair or flush) or outcomes are associated with different prizes. An example procedure may have a first price point in which the player only plays a regular round of video poker. The example procedure may have a second price point in which the player is eligible for a progressive jackpot (e.g. the player may win the progressive jackpot if the player is dealt a royal flush (i.e. ace, king, queen, jack, ten of the same suit). The example procedure may have a third price point where the player is eligible for the progressive jackpot and is actually dealt a bonus card such that if any combination of the 6 cards creates a royal flush the player may win the progressive jackpot. The example procedure may have a forth price point where the player is eligible for the progressive jackpot and is actually dealt two bonus cards such that if any combination of the 7 cards creates a royal flush the player may win the progressive jackpot. It should be appreciated that example procedures of increasing the probability of a progressive jackpot in a better than linear fashion as wager price points increase may be implemented on any number of games. Other examples may involve a slot machine game where a progressive jackpot may be won when five special symbols appear, if a wager had been placed at a certain price point, or a progressive jackpot may be won when four or more special symbols appear, if a wager had been placed at a higher price point and so on.

It will be appreciated that any of the above illustrated example procedures may be implemented on a video game terminal, on a personal computer possibly connected to the internet, with paper or electronic tickets sold at retail establishments, as part of a state lottery, as part of a multi-state lottery, on a mobile device (e.g. cell phone or PDA), or with any other instruments capable of facilitating the example procedures illustrated above. Additionally, it will also be appreciated that game selections, in number selection games or other games, may be made by a player or may be generated automatically, at the base game level or a progressive game level.

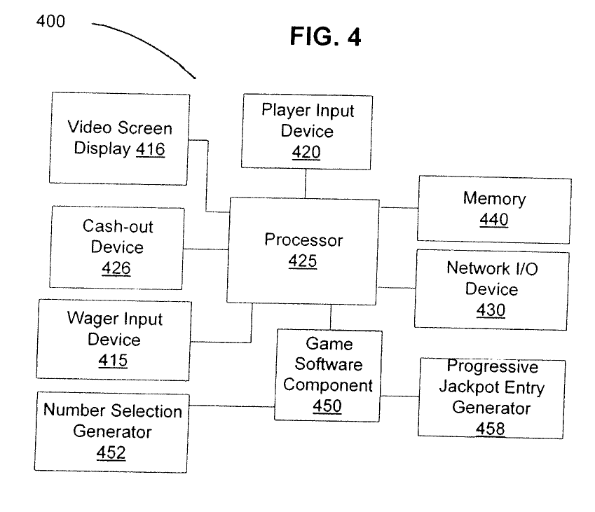

FIG. 4 illustrates a block diagram of an example system according to one example embodiment of the present invention. System 400 may have a processor 425 which may be in communication with several peripherals. System 400 may have a video screen display 416. The video screen display 416 may be configured to show the results of a round of a game, such as a number selection game (e.g. show which 20 numbers the operator selected, so that a player may compare those numbers to their selections). The example system may include a player input device 420, which may be any device which allows the system 400 to accept input from a user, for example, a conventional keyboard, an external number keypad, a joystick, a mouse, or the video display 416 itself may accept touch-screen input. The example system 400 may also include a wager input device 415. The wager input device 415 may be designed, for example, to accept paper bills, or other slips detailing credit, or may be a device which may read magnetically or electronically stored information. The system 400 may also include a network I/O device 430. The network I/O device 430 may be, for example, a serial port which may connect to a telephone line. The system 400 may also include a memory 440 which may be configured to store the various graphics and instructions required to operate video screen display 416.

The system 400 may also include a game software component 450. The game software component may contain the instructions for executing a game, such as a number selection game. The game software component 450 may have a progressive jackpot entry generator 458 that may be configured to determine if a wager entered at device 415 qualifies for a progressive jackpot entry and may generate that entry if needed. The game software component 450 may also contain a number selection generator 452. The number selection generator 452 may be responsible for randomly selecting a set of winning numbers (or otherwise determine a game outcome), in which a player's selected numbers must fall in order to win a jackpot. It is to be recognized that other system architectures may also be used. For example, example systems may include a remote terminal in communication with a centralized number selection game server (e.g. a state-wide keno game), and the network device 430 may be configured to informing the processor of number selections or other information generated by the server.

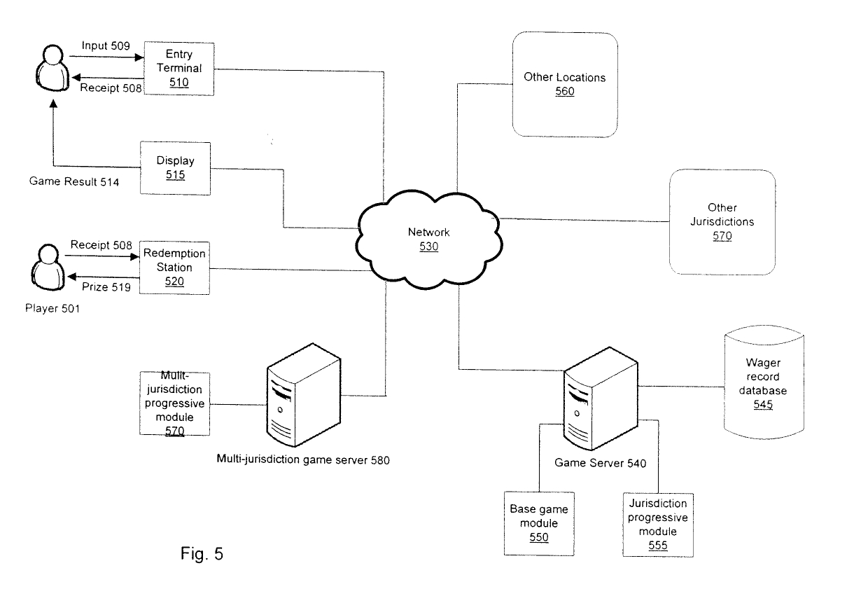

FIG. 5 illustrates a block diagram of an example distributed system according to one example embodiment of the present invention. FIG. 5 illustrates how a game may be distributed over a network 530. The system may include an entry terminal 510 configured to accept game selections and wager selections. The entry terminal 510 may also be configured to accept a wager selection or to accept the actual wager. In some examples, the entry terminal 510 may be configured to allow a player to interface directly with the entry terminal 510, while in other examples, the entry terminal 510 may be configured to be used by a retail clerk. The entry terminal 510 may also be configured to issue a receipt 508 for the entry. The system may have a display 515 that may be configured to show one or more players 501 results of a game 514. Other example systems may include a speaker that may be configured to announce the results of a game, for example announcing winning numbers, which other example systems may include a human announcer. The example system may have a redemption station 520 which may be configured to accept the entry of a receipt 508 to receive a prize 519. The system may include a network 530 which may be configured to interface with other locations 560 and other jurisdictions 570. The system may also include a game server 540 which may be configured to run games. The example system may also include a base game module 550 which may run on the server 540 and may be configured to run a base game. The example system may also include a jurisdiction progressive module 555 which may run on the server 540 and may be configured to run a jurisdiction-wide progressive game. The network 530 may also connect to a multi-jurisdiction game server 580 which may be configured with a multi-jurisdiction progressive module 570. The multi-jurisdiction progressive module 570 may be configured to determine if any player 501 has won a multi-jurisdiction progressive jackpot.

It will be appreciated that, in the above descriptions, reference has been made to “random numbers” and “random number generation.” It will be appreciated that this recitation includes both random sampling of physical events, the use of a computer software pseudo random number generator, a firmware or hardware random or pseudo random number generator, or the reference to external real world events that are effectively random for the purposes of the game, e.g., the least significant digit in the total trading volume on a stock exchange. Access may also be provided to a secure random number generator outside the system itself, e.g., a utility or service that provides the results of random external events, such as ball drawings used in conventional Lotto type games or pseudo-random numbers generated on another computer system, or access to other information that while perhaps not technically random in the mathematical sense, is unknowable in advance and effectively random for the purpose of the game, e.g., reference to particular sports or financial information, such as the last (least significant) digit in the total stock sales on the New York stock exchange, or the last (least significant) digit of the total number of pitches thrown in all the major league baseball games on a particular day. Where “random numbers” are referred to in the present application, it should be understood, unless expressly indicated otherwise, that any of the above approaches to random number generation are intended to be included. It is also appreciated that, the random numbers can be used to determine game outcomes; however, the determination, unless specifically required by the language of the claims need not be done in any particular location, it may be on a dedicated machine, a server, accessed over a network, etc.

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods, games, and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

It will further be appreciated that the above-described methods and procedures may be provided using the systems disclosed herein, or on other types of systems. The methods and procedures, unless expressly limited, are not intended to be read to require particular actors or systems performing particular elements of the claimed methods.

1. A method of facilitating the operation of a wagering game with a progressive jackpot, comprising:
receiving a player selection of a wager price point from a plurality of available price points for the wagering game;
conditioned on receiving the player selection of the wager price point, entering the player into a round of a base wagering game;
conditioned on the player selection of the wager price point exceeding a first predetermined threshold, also entering the player into a progressive jackpot game; and
conditioned on the player selection of the wager price point exceeding a second predetermined threshold, which is higher than the first predetermined threshold, also entering the player into a second progressive jackpot game.

2. The method of claim 1, further comprising:
responsive to the player selection of the wager price point exceeding the first predetermined threshold or the second predetermined threshold, generating at least one entry number, where a prize awarded for the game depends at least in part on the at least one entry number.

3. The method of claim 1, further comprising:
receiving a selection of at least one entry number from the player, wherein award of a prize for the round of the base wagering game depends at least in part on the at least one entry number.

4. The method of claim 1, further comprising:
randomly generating at least one outcome number, wherein award of a prize for the round of the base wagering game depends on the at least one outcome number.

5. The method of claim 1, wherein the base wagering game is a number selection game, and further comprising:
receiving a selection of at least one entry number from the player chosen from a set of numbers,
generating at least one outcome number chosen from the set of numbers,
awarding a prize for the round of the base wagering game based on the quantity of entry numbers that match outcome numbers.

6. The method of claim 5, wherein:
the set of numbers includes 80 numbers; and
the outcome numbers include 20 numbers selected from the set of numbers.

7. The method of claim 4, wherein the base wagering game is a number selection game, further comprising:
awarding the first progressive jackpot and the second progressive jackpot based on the at least one outcome number used in the base wagering game.

8. The method of claim 4, wherein the base wagering game is a number selection game, further comprising:
awarding the first progressive jackpot based on a second number drawing separate from the base wagering game; and
awarding the second progressive jackpot based on a third number drawing separate from the base wagering game and the first progressive jackpot game.

9. The method of claim 8, wherein the first progressive jackpot is a jurisdiction-wide progressive jackpot.

10. The method of claim 9, wherein the first progressive jackpot is a multi-jurisdiction progressive jackpot.

11. A method of providing a wagering game with a progressive jackpot, comprising:
receiving a player selection of a wager price point;
responsive to receiving a selection of a first price point, entering the player into a base wagering game;
responsive to receiving a selection of a wager price point exceeding a second price point, higher than the first price point, entering the player into a progressive jackpot; and
responsive to receiving a selection of a wager price point exceeding of a third price point, higher than the second price point, entering the player into the progressive jackpot; wherein:
a probability of winning the progressive jackpot associated with the entry exceeding the third price point, is greater than a second probability of winning associated with the entry exceeding the second price point but less than the third price point, and
an increase in probability between the probability and the second probability is non-linear as compared to an increase in price between the second price point and the third price point.

12. The method of claim 11, wherein the wagering game is a number selection game, and the method further comprising:
receiving a selection of at least one selected entry number chosen from a set of numbers;
receiving a selection of at least one randomly selected outcome number chosen from the set of numbers; and
awarding a prized based on how many selected entry numbers match outcome numbers.

13. The method of claim 12, further comprising:
responsive to receiving a selection of the second price point, issuing at least one player entry number and randomly selecting at least one outcome number, wherein the quantity of outcome numbers is greater than or equal to the quantity of player entry numbers; and
awarding the progressive jackpot responsive to a determination that each player entry number matches an outcome number.

14. The method of claim 12, further comprising:
responsive to receiving a selection of a price point exceeding the third price point, issuing at least one player entry number and selecting at least one outcome number, wherein the quantity of outcome numbers is greater than or equal to the quantity of player numbers and the quantity of entry numbers is less than a second quantity of entry numbers associated with the second price point; and
awarding the progressive jackpot responsive to a determination that each player number matches a operator number.

15. The method of claim 12, wherein:
the set of numbers includes 80 numbers; and
the outcome numbers include 20 numbers.

16. A system for facilitating a number selection game with a progressive jackpot, comprising:
an input device configured to receive a player selection of a wager amount chosen from a set of available wager amounts;
a processor; and
an output device configured to inform the player of at least one winning number; wherein:
the processor is configured to receive at least one entry number, to receive randomly generated outcome numbers; and to determine whether a wager is a winner based on the at least one entry number and the randomly generated outcome numbers, the probability of a winning wager increasing more than linearly with the chosen wager amount.

17. The system of claim 16, wherein:
the input device is configured to accept paper tickets marked with the at least one number and the player selection of the wager amount.

18. The system of claim 16, wherein the input device is an electronic kiosk configured to be operated by at least one of the player and a retail clerk, the input device configured to receive input indicating the at least one entry number and the player selection of the wager amount.

19. The system of claim 16, wherein:
the processor is further configured to randomly choose the outcome numbers.

20. The system of claim 16, wherein:
the processor is further configured to enter the player in a progressive jackpot game responsive to the selection of a first wager amount and the processor is configured to issue at least one first set of numbers on which an award of a progressive jackpot depends; and
the processor is further configured to enter the player in the progressive jackpot game responsive to the selection of a second wager amount, greater than the first wager amount, and the processor is configured to issue at least one second set of numbers, of a lesser quantity than the first set of numbers, on which an award of the progressive jackpot depends.

21. The system of claim 16, wherein:
the processor is further configured to enter the player in a progressive jackpot game, responsive to a first wager amount being selected which is greater than a minimum wager amount; and
the processor is further configured to enter the player in a second progressive jackpot game responsive to a second wager amount being selected which is greater than a second minimum wager amount, the second minimum wager amount being greater than the minimum wager amount.

22. A method of providing a number selection game with a progressive jackpot, comprising:
receiving a selection of a wager price point from a player;
responsive to the wager price point being greater than or equal to a first price point, entering the player in a number selection game;
responsive to the wager price point being greater than or equal to a second price point that is greater than the first price point, issuing the player a first quantity of numbers such that winning a jurisdiction-wide progressive jackpot game is dependant on the numbers in the first quantity of numbers;
responsive to the wager price point being greater than or equal to a third price point, that is greater than the second price point, issuing the player a second quantity of numbers, smaller than the first quantity of numbers, such that winning a jurisdiction-wide progressive jackpot game is dependent on the numbers in the second quantity of numbers;
responsive to the wager price point being greater than or equal to a fourth price point, greater than the third price point, making the first quantity of numbers eligible for a multi-jurisdiction progressive jackpot; and
responsive to the wager price point being greater than or equal to a fifth price point, greater than the fourth price point, making the second quantity of numbers eligible for a multi-jurisdiction progressive jackpot.

23. The method of claim 22, further comprising:
selecting from a set of numbers some final quantity of numbers; and
determining winners based on matching the numbers in the first or second quantity of numbers with the final quantity of numbers.

24. A system for facilitating the operation of a game;
an input means for receiving a player selection of a wager amount and player entry numbers;
an entry means for entering the player's wager in the game, the player entry including additional chances to win conditioned on the player's wager exceeding predetermined thresholds;
a randomization means for generating outcome numbers;
an outcome determination means for determining whether the player's wager wins a base game based on a comparison of the entry numbers and the outcome numbers.

25. The system of claim 24, wherein the additional chances to win include entries in jurisdiction-wide progressive games.

26. The system of claim 24, wherein the additional chances to win include entries in multi-jurisdiction progressive games.

27. The system of claim 24, wherein the selection of a wager price point from a player is received by at least one of a dedicated gaming kiosk, a clerk-operated gaming terminal, a clerk-operated point-of-sale terminal, an unattended game ticket vending machine, a personal computer connected over the Internet to a lottery server, and a mobile telephone wirelessly connected to a lottery server.

28. The method of claim 1, wherein the player selection of a wager price point is received by at least one of a dedicated gaming kiosk, a clerk-operated gaming terminal, a clerk-operated point-of-sale terminal, an unattended game ticket vending machine, a personal computer connected over the Internet to a lottery server, and a mobile telephone wirelessly connected to a lottery server.

29. The method of claim 11, wherein the player selection of a wager price point is received by at least one of a dedicated gaming kiosk, a clerk-operated gaming terminal, a clerk-operated point-of-sale terminal, an unattended game ticket vending machine, a personal computer connected over the Internet to a lottery server, and a mobile telephone wirelessly connected to a lottery server.

30. The method of claim 4, wherein the least one outcome number is randomly generated by at least one of a software pseudo-random number generator on a gaming server, a firmware based pseudo-random number generator on a gaming server, a hardware based random number generator in communication with a gaming server, and a software pseudo-random number generator on gaming terminal.

31. The method of claim 12, wherein the at least one randomly selected outcome number chosen from the set of numbers is selected using at least one of a software pseudo-random number generator on a gaming server, a firmware based pseudo-random number generator on a gaming server, a hardware based random number generator in communication with a gaming server, and a software pseudo-random number generator on gaming terminal.

32. The method of claim 23, wherein the final quantity of numbers are selected by at least one of a software pseudo-random number generator on a gaming server, a firmware based pseudo-random number generator on a gaming server, a hardware based random number generator in communication with a gaming server, and a software pseudo-random number generator on gaming terminal.
